(19) United States
(12) Patent Application Publication
(10) Pub. No.: US 2012/0312888 A1
(43) Pub. Date: Dec. 13, 2012

(54) THIN INVERT COMPOSITIONS FOR SPRAY APPLICATION

(76) Inventor: Roy R. Johnson, Ambler, PA (US)

(21) Appl. No.: 13/490,714

(22) Filed: Jun. 7, 2012

Related U.S. Application Data
(60) Provisional application No. 61/495,427, filed on Jun. 10, 2011.

(51) Int. Cl. B05B 15/00; A01P 13/00; A01N 43/50; A01N 43/54; A01N 57/20

(52) U.S. Cl. 239/1; 504/239; 504/206; 504/253; 504/198

(57) ABSTRACT

An improved thin invert composition and method for applying agricultural products to a target area with minimal drift or evaporation is disclosed, based on a water and oil mixture which is emulsified by minimal agitation so as to provide a low viscosity emulsion. The emulsion, when sprayed through small spray orifices (e.g., 0.020 inch internal diameter) forms a thin invert wherein the water phase is enclosed in the oil phase and the droplet size is small (e.g., 1000 microns mean diameter) and uniform. The water phase carries a hydrophilic active agricultural product.

### CROSS REFERENCE TO RELATED APPLICATION

This application claims the benefit of U.S. Provisional Application No. 61/495,427 filed Jun. 10, 2011.

### FIELD OF THE INVENTION

The present invention relates to an improved “thin invert” composition for carrying agricultural products to a target area, such as a field of growing crops, in the form of a spray of uniform small droplets. More specifically, the invention relates to low viscosity water and oil emulsions for carrying hydrophilic agricultural products such as herbicides, insecticides, fungicides and/or plant growth regulators.

### BACKGROUND OF THE INVENTION

Oil/water emulsions are known per se, and have been used for agricultural applications as a means to form larger droplets when the emulsion is sprayed, as compared for example to a dispersion of the agricultural product in water. A larger droplet has more inertia than a smaller one, and is less apt to drift. Drift is a problem, particularly in aerial application of the agricultural product, allowing a portion of the product to escape due to air currents carrying the product away from the target area, evaporation, etc. At worst the drifting product can pollute the environment, for example adversely affecting areas surrounding the area of intended application. At the very least, a portion of the product fails to reach the target crop or the like and is wasted.

A number of factors affect droplet size including the viscosity of the composition, its surface tension, the geometry and flow conditions of the spray apparatus which emits the composition, and the relative motion of the air stream into which the spray is emitted. These factors are interrelated. For example, a composition with a relatively high surface tension may be capable of forming a large droplet under optimal conditions, but under typical spray conditions the viscosity, spray geometry and/or flow conditions are so variable that the spray is broken up into a range of droplet sizes. The larger droplets tend to fall and the smaller droplets tend to drift. It is difficult to prevent the breakup of larger droplets into smaller ones, particularly considering the fact that the high viscosity of the composition needed to produce a large droplet size requires a large diameter flow path and spray orifice in order to flow properly. Moreover, viscosity varies with temperature, minor variations in water quality, agitation, etc.

The efficacy of the agricultural agent in the composition is affected by the droplet size. The general objectives when spraying are to coat the target area evenly and completely, and to apply the composition in a quantity per unit of area that will achieve the desired results. However, when the droplet size is large or variable these factors are also variable. With respect to leafy vegetation, for example, large droplets applied at a given quantity per unit area are more likely to spot the leaves than to coat them evenly. Therefore, large droplets may be helpful against drift but require a higher rate of application to achieve a given efficacy.

Some active agricultural products can be dispersed in either water or oil. However, many forms of vegetation have a more or less waxy surface which protects the plant from dehydration due to evaporation from the leaves. This waxy coating also interferes with the absorption of water into the leaves. Accordingly, spray compositions with water soluble agricultural products are often considered less advantageous than oil based compositions because the active ingredient can be blocked from penetrating the leaves due to the waxy coating.

Known oil/water emulsions, particularly when applied by aerial spraying, have additional drawbacks. When ambient temperatures rise, the more volatile media tend to evaporate from the emulsion more quickly, and may release the active agricultural product into the air rather than onto the target. When a droplet containing a mixture of a water soluble active ingredient, water and oil is sprayed, at least some of the water on the surface of the droplet tends to evaporate or separate from the droplet, thereby wasting the agricultural product and impeding drift control. Under such circumstances, the droplets (primarily remaining oil) are reduced in size and can float more readily in the air and be carried from the target by the wind.

As mentioned above, the droplet size of a sprayed composition can be increased by using a thick so-called “invert.” An invert is an emulsion characterized by droplets having a film of oil surrounding one or more water particles, and thick inverts are viscous compositions of this type. The oil phase surrounding the water phase reduces the evaporation of the water and consequent loss of the active ingredient. However, thick invert emulsions form non-uniform droplets when sprayed. Due to the large and non-uniform character of the droplets, thick inverts require higher spray volumes per unit of area to achieve a given efficacy than might be obtained with smaller droplets of a uniform size, which can more evenly coat the leaves A typical thick invert may require application rates of 25 to 100 gallons per acre.

A known, boom-type aerial agricultural spray device is disclosed in U.S. Pat. No. 5,110,048 which is hereby incorporated by reference. A plurality of orifices are provided on the trailing edge of an airfoil shaped conduit which is elongated transverse to the direction of travel of an aircraft, for example on the front of the skids of a helicopter or below the wing of a fixed-wing aircraft. The orifices are arranged on nozzles which are wedge-shaped along their trailing edge, each having a valve coupled to a port which protrudes at a fitting on the leading edge of the airfoil.

A conventional delivery system is characterized by substantial disturbance of the laminar flow of air passing the aircraft or the like. The disturbance interferes with formation of uniform droplets. This is particularly true when a conventional boom is used with fixed-wing aircraft (where turbulence generated by the wing further disturbs the laminar flow around the spray boom). The conventional device emits the liquid in a distribution of larger and smaller droplets. Droplets larger than optimum require high application rates. Droplets smaller than optimum tend to drift. In all, the known device is largely subject to drift and waste.

Assuming that a uniform application of small droplets can be accomplished, the volume of material applied to a site to be treated can be reduced. With more accurate application, a more concentrated agent can be applied safely. Smaller, lighter equipment can be used to apply the material, and the effectiveness of the agent is improved. Moreover, when the small droplets can be formed as an invert with a water phase enclosed in an oil surface layer, problems with evaporation are reduced. In addition, the oil assists in penetration of the waxy surface of vegetation, and the overall efficacy of the chemical agent is improved.

According to the invention, a composition is provided which can be readily applied through small orifice spraying devices arranged to form uniform small droplets. The orifices are capillary sized in relation to the composition viscosity and surface tension. The composition is low in viscosity and is agitated to maintain the oil and water against separation or to reconstitute the emulsion after separation. This is accomplished, for example, by recirculating the composition in the spray apparatus, using the spray pump or an auxiliary pump associated with the spray apparatus. The agitation converts the oil and water phases into a thin invert which produces a droplet having an oil phase over a water phase, the oil phase providing protection against evaporation of the water phase, and producing surface tension characteristics needed to maintain droplet size.

The compositions of the invention produce uniform small droplets that provide excellent efficacy in low volume applications. The viscosity of the compositions are low, as appropriate for emission through numerous small orifices to form small droplets. The viscosity of the compositions can also be controlled by regulating the extent of agitation. Therefore, problems with separation of the oil and water portions of the formulations are overcome, allowing an invert solution to be applied in uniform small droplets. In connection with aerial spraying, a plurality of wedge shaped nozzles along an aerodynamically shaped conduit are each provided with trailing small tubes leading to an internal manifold coupled to the conduit at a check valve. A pump coupled between a storage reservoir and an end of the conduit pressurizes the conduit to open the check valves and commence application of the product. A second conduit runs along the conduit and is preferably disposed inside the conduit. The second conduit is arranged in a recirculation path adapted to agitate the material in the system to prevent separation and to regulate the viscosity of the composition, which varies with agitation, temperature and ingredients.

### SUMMARY OF THE INVENTION

It is an object of the invention to provide a thin invert composition for the application of agricultural products to a target in the form of uniform small droplets of water in oil.

Another object of the invention is to provide a thin invert composition which together with a recirculating delivery system reduces the incidence of drift in aerial spray applications.

Still another object of the invention is to provide a thin invert system which may be used with water soluble and water miscible agricultural products.

Another object of the invention is to provide a thin invert system capable of using hydrophilic product.

Yet another object of the invention is to provide a thin invert system that prevents unwanted evaporation of agricultural product prior to deposition on the target area.

It is a further object of the invention to provide a thin oil/water invert composition arranged such that the surface tension of the liquid is the primary effect determining droplet size, which can be applied through small orifices for delivery of uniform small droplets.

These and other objects of the invention are achieved by providing a thin invert composition according to the invention and a method of applying the composition, preferably comprising a hydrophilic product with an invert oil coating, substantially without drift to a target area. The hydrophilic product is present in the water phase of an oil/water mixture which is agitated to form an emulsion. The emulsion is particularized by delivery through small orifices to produce substantially uniform droplets having a maximum mean droplet diameter of about 500-1000 micrometers. The droplets comprise an invert emulsion, i.e., the oil phase surrounds the water phase, which water phase contains the hydrophilic product. The viscosity is low enough to permit droplet formation through a nozzle having an orifice size of from about 0.007 inches to about 0.02 inches and having about 5 to 54 orifices per nozzle, a flow rate of about 0.1 liters per minute per orifice and at ambient temperatures of about 60-90° F. The droplets are applied to a target area, for example, by aerial spraying onto growing crops and plants, such as fruits, vegetables and weeds. In a preferred embodiment, the hydrophilic product is aminocyclopyrachlor.

The invention makes possible the use of water soluble and water miscible agricultural products in aerial sprays with reduced drift, evaporation and acceptable leaf wetting and penetration at relatively low application rates, such as 1-5 gallons per acre.

The capability of agitating the liquid agent by recirculating the agent in the system prevents separation of the oil and water phases. Even after a period of inactivity the agent can be reconstituted by operating the recirculating means.

### DETAILED DESCRIPTION OF THE INVENTION

In accordance with the present invention, by adding at least 50% more water to the emulsion, forming a three parts water: one part concentrate emulsion, rather than a 2:1 emulsion, a more viscous, more useful emulsion was formed. This emulsion was more suitable for use through nozzles as described in U.S. Pat. No. 5,248,086, herein incorporated by reference, than the 2:1 emulsion; in addition, it is more efficient, as it contains 75% water instead of 67% as in a standard commercial product. This formulation also appears to require less vigorous agitation to form an invert emulsion than the paraffinic based concentrate.

In order to determine the stability (lack of separation of oil and water phases of the invert emulsion), various sample emulsions at both 2:1 and 3:1 water: oil ratios and emulsions with Krenite® herbicide as the active ingredient were prepared. All emulsions made with methyl oleate as the oil phase remained stable for at least two months.

Thus, the present invention relates to the use of methylated seed (e.g., soy) oil as a solvent for forming a useful thin invert emulsion for applying pesticides to control vegetation or other undesirable pests. These thin invert emulsions have been shown to reduce spray volumes, reduce spray drift, and increase efficacy of pesticide sprays. Methylated soy oil (MSO) formulations of thin invert emulsions also form more stable emulsions than existing formulations that use a paraffinic petroleum oil to form the oil phase. Adding 50% more water to the spray emulsion makes the application more economical. Use of a methylated seed oil replaces the use of a scarce, more expensive petroleum solvent with an environmentally more desirable and available solvent.

Weight percentage ranges of ingredients in new MSO concentrate formulations are as follows: Emulsifier (Hypermer™ 2234)—Range: 2% to 4% with preferred range of 2-2.5%; Surfactant (Silwet™ 7607)—Range: 0.2-0.3% with 0.2% preferred concentration.

In the use of the present invention, a concentrate formulation is diluted with two parts water before adding active ingredients, usually herbicides. Active ingredient concentrations may range from 0.5% to 10%, depending on activity level and desired result, and are usually used in combinations. A limited amount of product is sold as THINVERT® RTU (ready-to-use) formulation that has water and concentrate mixed in a 2:1 ratio. It is anticipated that reducing the amount of emulsifier to maintain the preferred viscosity rather than changing the ratio of water to oil will provide favorable results. A paraffinic oil formulation required 3.8-4% emulsifier to form mixtures with the preferred viscosity, while the MSO formulation requires substantially less, down to 2-2.5%. In addition, the MSO formulation forms more stable water in oil emulsions than the paraffinic one.

The solvent that may be used is SOYGOLD® 1100 Solvent, manufactured by AG Environmental Products. A significant advantage of this solvent is its high flash point, 425° F. (therefore less flammable), compared to that of e.g., Isopar^{TM} M, with a flash point of 190 ° F. Some THINVERT formulation/herbicide mixtures become too viscous to be readily sprayed through the small orifices in THINVERT formulation nozzles. It is proposed to add a commercial surfactant (e.g., a commercial laundry detergent) of about one quart detergent or surfactant per 50 gallons, and to repeat the addition if additional thinning is required.

Applications are generally made at a volume of five gallons emulsion per acre. The droplets spread well on the surface of plant foliage, and necrosis of foliage on the treated brush is similar with both applications.

The new formulations are manufactured in the same manner and equipment as the prior formulations, with the exception of a reduction in the concentration of emulsifier in the new formulations. The specific gravity of the two solvents, 0.79 for the Isopar™ M and 0.88 for the SOYGOLD seed oil ester, has been taken into account.

In further testing of the present invention, helicopter right-of-way side trimming applications were made with the new THINVERT ®formulation using a concentration of 7% Krenite S® fosamine herbicide in a THINVERT® emulsion, and employing a vertical spray boom suspended 50 feet below helicopter. The 20 foot boom was equipped with five THINVERT® Widecast™ nozzles and applied a 30 to 40 foot swath to control tree branches at the sides of a transmission line and to keep new growth from growing into the right-of-way. Vegetation was primarily sweet gum, various oak species, Virginia pine, and loblolly pine. Evaluation after 45 days showed 90 to 100% necrosis or brownout of treated branches, considered excellent results for the practice. The treatment is designed to control treated branches with no translocation of the herbicide to the rest of the tree.

Ground applications were also made to woody vegetation on power transmission lines at several locations in Arizona. Equipment used was backpack sprayers using THINVERT® backpack nozzles or spray systems mounted on ATV vehicles or other similar vehicles equipped with THINVERT® Widecast nozzles. Several different treatments were applied, but evaluations were made on a combination of 7% Accord® glyphosate herbicide and 2% Habitat® imazapyr herbicide in a THINVERT® emulsion. Evaluation 30 to 45 days after application at several sites in Arizona showed excellent initial control of salt cedar and associated desert and upland woody vegetation. In addition, applications to plots and subsequent applications to utility rights-of-way months later provided essentially complete control of such vegetation.

While the present invention has been described with respect to particular embodiments thereof, it is apparent that numerous other forms and modifications of the invention will be obvious to those skilled in the art. The appended claims and the present invention generally should be construed to cover all such obvious forms and modifications which are within the true spirit and scope of the present invention.

What is claimed is:

1. A composition for application of active agricultural agents, comprising effective amounts of a mixture of:
a methylated seed oil phase, an emulsifier/surfactant and a water phase, said water phase containing an active hydrophilic product of up to 75% by weight of the water phase, wherein an emulsion of at least three parts water phase to one part oil phase is formed, wherein the mixture has a viscosity sufficient to produce droplets of about 1000 micrometers mean maximum diameter when pumped through a capillary sized orifice, whereby the emulsion forms a thin invert when sprayed for application of the hydrophilic product to a target area.

2. The composition according to claim 1, further comprising an effective amount of at least one additive regulating an attribute of the composition selected from the group consisting of viscosity, surface resistance, pH, odor, and intra-ingredient compatibility.

3. The composition according to claim 2, wherein the additive includes at least one of an emulsifier and a surfactant.

4. The composition according to claim 1, wherein the active hydrophilic product is selected from the group consisting of a herbicide, an insecticide, a fungicide and a plant growth regulator.

5. The composition according to claim 4, wherein the active hydrophilic product is selected from the group consisting of 2,4-D, dicamba, triclopyr, imazapyr, glyphosate, sulfometuron methyl, fluridone, clopyralid, picloram, hexazinone, chlorpyriphos, carbaryl, methomyl, ethephon, fosamine, benomyl, ferbam and zineb.

6. The composition according to claim 4, wherein the active hydrophilic product is aminocyclopyrachlor.

7. A method of applying a hydrophilic product substantially without drift to a target area, said method comprising the steps of: forming a thin invert water-in-oil emulsion comprising a mixture by weight of a methylated seed oil phase, an emulsifier/surfactant and a water phase, said water phase containing an active hydrophilic product of up to 75% by weight of the water phase, wherein an emulsion of at least three parts water phase to one part oil phase is formed, and further comprising at most 5% of at least one additive for regulating an attribute of the mixture, selected from the group consisting of viscosity, surface resistance, pH, odor, and intra-ingredient compatibility;
particulating at least a portion of said emulsion to produce substantially uniform droplets having a maximum mean droplet diameter of about 500-1000 micrometers, said droplets comprising an oil phase surrounding a water phase, which water phase contains said hydrophilic product, said emulsion having viscosity which permits said particulation to occur through a small orifice nozzle means; and,
applying said particularized droplets to said target area.

8. The method according to claim 7, wherein the particulating is performed by flowing the emulsion through at least one nozzle having an orifice size of from about 0.007 inches to about 0.02 inches, at a flow rate of about 0.1 liter per minute per orifice and at ambient temperatures of about 60-90° F.

9. The method according to claim 7, further comprising at least one of reconstituting and regulating viscosity of the emulsion by agitation.

10. The method according to claim 7, wherein said hydrophilic product is selected from the group consisting of hydrophilic herbicides, insecticides, fungicides and plant growth regulators.

11. The method according to claim 7, wherein said hydrophilic product is a water soluble or water miscible amine.
